(19) United States
(12) Patent Application Publication
(10) Pub. No.: US 2010/0175004 A1
(43) Pub. Date: Jul. 8, 2010

(54) VIRTUAL MEETING BOOTH

(75) Inventor: Rohit Deep, Union City, CA (US)

Correspondence Address: Patent Capital Group - Cisco, 6119 McCommas, Dallas, TX, 75214, US

(73) Assignee: Cisco Technology, Inc., San Jose, CA (US)

(21) Appl. No.: 12/349,704

(22) Filed: Jan. 7, 2009

(51) Int. Cl. G06F 15/16; G06F 3/048

(52) U.S. Cl. 715/758; 709/204

(57) ABSTRACT

In one embodiment, a method includes obtaining, at a first location, a request to initiate a web conference. The request is obtained from a first party. The method also includes communicating with a second location configured to create the web conference based on the request, and determining when the web conference is created by the second location. If it is determined that the web conference is created by the second location, the method further includes issuing an invitation to at least a second party to invite the second party to participate in the web conference with the first party.

### BACKGROUND OF THE INVENTION

The present invention relates generally to conferencing systems.

A web conference, or a virtual meeting, is a conference that is conducted over a network, e.g., the Internet. Web conferencing allows a visual component to be incorporated into conference calls. That is, web conferencing allows participants in a web conference to view the same visual display at substantially the same time while the web conference is ongoing.

Web conferencing allows applications to be shared amongst participants in a web conference. One participant in a web conference may share an application viewed on his or her computer with other participants, and enable other participants to effectively control the application. In other words, a participant in a web conference may share what is displayed on his or her computer display screen with other participants. For example, a participant in a virtual meeting may share his or her web browser application with other participants such that substantially all participants in the virtual meeting may view the web browser application and, hence, a web page that is displayed within the web browser application.

Typically, to host a web conference, a user accesses a web conferencing application to establish an account. Once the account is established, the user may then initiate a web conference by inviting parties to participate in the web conference, and paying for the web conference. The establishment of the web conference allows the user to share something he or she is viewing on his or her computing system with other participants in the web conference.

### BRIEF DESCRIPTION OF THE DRAWINGS

The invention will be readily understood by the following detailed description in conjunction with the accompanying drawings in which:

FIG. 1 is a process flow diagram which illustrates one method of establishing a virtual meeting using a virtual meeting booth in accordance with an embodiment of the present invention.

FIG. 2 is a process flow diagram which illustrates one method of joining a virtual meeting using a virtual meeting booth in accordance with an embodiment of the present invention.

FIG. 3 is a diagrammatic representation of interactions associated with organizing a virtual meeting using a virtual meeting booth in accordance with an embodiment of the present invention in which parties to the virtual meeting communicate through substantially only a website that supports the virtual meeting booth.

FIG. 4 is a diagrammatic representation of interactions associated with organizing a virtual meeting using a virtual meeting booth in accordance with an embodiment of the present invention in which parties to the virtual meeting communicate through substantially directly and through a website that supports the virtual meeting booth.

FIG. 5A is a diagrammatic representation of a web page on which a virtual meeting booth icon is displayed in accordance with an embodiment of the present invention.

FIG. 5B is a diagrammatic representation of a window which opens relative to a web page, e.g., web page 524 of FIG. 5A, after a user activates a virtual meeting booth icon in accordance with an embodiment of the present invention.

FIG. 6 is a block diagram representation of a system in which a website may include an associated with a virtual meeting booth in accordance with an embodiment of the present invention.

FIG. 7 is a diagrammatic representation of the activation of a virtual meeting booth which includes opening an instant messaging interface in accordance with an embodiment of the present invention.

### DESCRIPTION OF EXAMPLE EMBODIMENTS

### General Overview

According to one aspect of the present invention, a method includes obtaining, at a first location, a request to initiate a web conference. The request is obtained from a first party. The method also includes communicating with a second location configured to create the web conference based on the request, and determining when the web conference is created by the second location. If it is determined that the web conference is created by the second location, the method further includes issuing an invitation to at least a second party to invite the second party to participate in the web conference with the first party.

### Description

Typically, if a first party wishes to share an element displayed on his or her computer, the first party accesses a separate web conferencing application that allows him or her to share the element. By way of example, if a first party wishes to share a web page that he or she is currently viewing on the desktop of his or her computer, that first party logs into a web conferencing application to create a web conference that enables him or her to share the web page. Any party that the first party invites to participate in the web conference then logs into the web conferencing application in order to join the web conference. To log into a web conferencing application, a party is generally substantially required to have an account with that web conferencing application. Unless a party has an account with a web conferencing application, the party is typically unable to participate in a web conference hosted by the web conferencing application.

Allowing a user of a web application to share his or her view of that web application to create a virtual meeting through that web application allows the virtual meeting to be efficiently created. A user may use the web application he or she wishes to share to actually cause a virtual meeting or a web conference to be created substantially without having an account with a web conferencing application. By way of example, a user may initiate a virtual meeting that allows him or her to share a web page displayed on his or her web browser essentially without having an account with a web conferencing application. In addition to allowing virtual meetings to be created without substantially requiring that participants have an account with a web conferencing application, the virtual meeting may be initiated and held without requiring payment from any of the participants in the virtual meeting, including the meeting initiator.

A virtual meeting booth may be presented on a website as a logo or an icon. Once a user activates, e.g., clicks on, a graphical representation of the virtual meeting booth, the user may invite others on the website to participate in a virtual meeting. It should be appreciated that the user may also invite parties who are not currently on the website. Such parties may be invited to access the website to join a virtual meeting. The virtual meeting may be centered around a web page of the website, or may be associated with any subject. That is, the virtual meeting may be based on a web page of a website, or may be based on substantially any subject.

In one embodiment, a party who accesses a virtual meeting booth associated with a web application may invite another party who is online with respect to that web application substantially without knowing the identity of that party. That is, a virtual meeting set up through the use of a virtual meeting booth associated with a web application may be created among parties who are currently online with respect to the web application. A party who initiates the virtual meeting may invite those currently online with respect to the web application to join the virtual meeting substantially without specifying information which identifies those currently online.

A virtual meeting booth may be arranged to support one meeting at a time, or may be arranged to support multiple meetings. When a virtual meeting booth enables more than one meeting to be supported, a user who activates the virtual meeting booth may be provided with information regarding different meetings which are currently ongoing. Similarly, a party who is invited to join a virtual meeting created using a virtual meeting booth may, upon accessing the virtual meeting booth, be provided with information regarding different meetings which are currently ongoing.

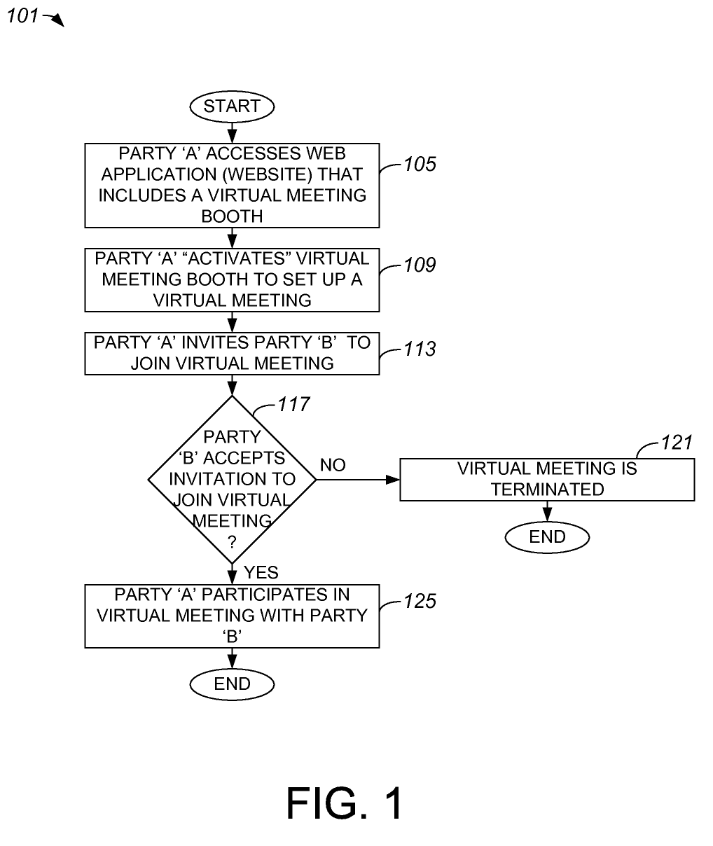

Referring initially to FIG. 1, a process of establishing a virtual meeting using a virtual meeting booth will be described in accordance with an embodiment of the present invention. A process 101 of establishing a virtual meeting using a virtual meeting booth begins at step 105 in which party ‘A’, e.g., a party who intends to initiate a virtual meeting or a web conference, accesses a web application that includes a virtual meeting booth. A web application such as a website may include a web page that displays a virtual meeting booth graphic or icon which allows a virtual meeting booth to be activated. The virtual meeting booth may also, in one embodiment, be activated by making a menu selection. It should be appreciated that although a web application is generally described, a virtual meeting booth is not limited to being associated with a web application. By way of example, a virtual meeting booth may be associated with a desktop of a computing device or any suitable application.

After party ‘A’ accesses the web application, party ‘A’ “activates” the virtual meeting booth to set up a virtual meeting in step 109. Activating the virtual meeting booth generally includes causing a menu that facilitates the initiation of a virtual meeting to be displayed. When the virtual meeting booth is presented as a logo or an icon displayed on a web page, the virtual meeting booth may be activated by party ‘A’ when party ‘A’ clicks on the logo. On the other hand, when the virtual meeting booth is presented as a menu selection, the virtual meeting booth may be activated by party ‘A’ when party ‘A’ makes an appropriate menu selection.

In step 113, party ‘A’ effectively uses the virtual meeting booth to invite party ‘B’ to join a virtual meeting. For ease of discussion, party ‘A’ is described as inviting a single party to join a virtual meeting. It should be appreciated, however, that any number of parties may be invited to join the virtual meeting. In general, party ‘B’ may be online with respect to the web application at the time party ‘A’ activates the virtual meeting booth. When party ‘B’ is online with respect to the web application, party ‘B’ may effectively be invited by party ‘A’ to join a virtual meeting without party ‘A’ having any information which identifies party ‘B’. However, party ‘B’ may instead be someone who is essentially targeted by party ‘A’, and may be offline with respect to the web application. Party ‘B’ may be invited to join a virtual meeting using the web application, e.g., the web application may inform party ‘B’ that party ‘A’ has started a virtual meeting which may be joined by party ‘B’. Party ‘B’ may also be separately invited to join a virtual meeting, e.g., party ‘A’ may contact party ‘B’ using a different modality than the web application. For instance, party ‘A’ may call, send an e-mail to, or send an instant message to party ‘B’ that informs party ‘B’ of a virtual meeting that party ‘A’ would like party ‘B’ to join via the web application. It should be appreciated that party ‘B’ may generally be informed that the virtual meeting is to be joined through activating a virtual meeting booth presented in the web application, and not through directly accessing or logging into a web conferencing application that hosts virtual meetings.

After party ‘A’ invites party ‘B’ to join a virtual meeting, process flow moves to step 117 in which a determination is made as to whether party ‘B’ accepts the invitation to join the virtual meeting. That is, it is determined whether party ‘B’ has joined the virtual meeting. In one embodiment, a time period for response may be specified such that if the time period expires before party ‘B’ accepts the invitation, party ‘B’ is considered to have declined the invitation. Such a time period may be specified by the web application or party ‘A’.

If it is determined that party ‘B’ has not accepted the invitation to join the virtual meeting, the virtual meeting is terminated in step 121. The virtual meeting may be terminated by party ‘A’, the web application, or a server which hosts the virtual meeting. Once the virtual meeting is terminated, the process of establishing a virtual meeting is completed.

Alternatively, if it is determined in step 117 that party ‘B’ has accepted the invitation to join the virtual meeting, then party ‘A’ participates in a virtual meeting with party ‘B’ in step 125. The virtual meeting is generally hosted by a web conferencing application. In general, the virtual meeting is created by the web conferencing application in response to party ‘A’ activating the virtual meeting booth associated with the web application. The web application and the web conferencing application are substantially separate, although the web conferencing application is effectively activated through the virtual meeting booth presented with respect to the web application. In one embodiment, content associated with the web application, as for example a web page of the web application, is to be shared during the virtual meeting. The process of establishing a virtual meeting is completed upon party ‘A’ and party ‘B’ participating in the virtual meeting.

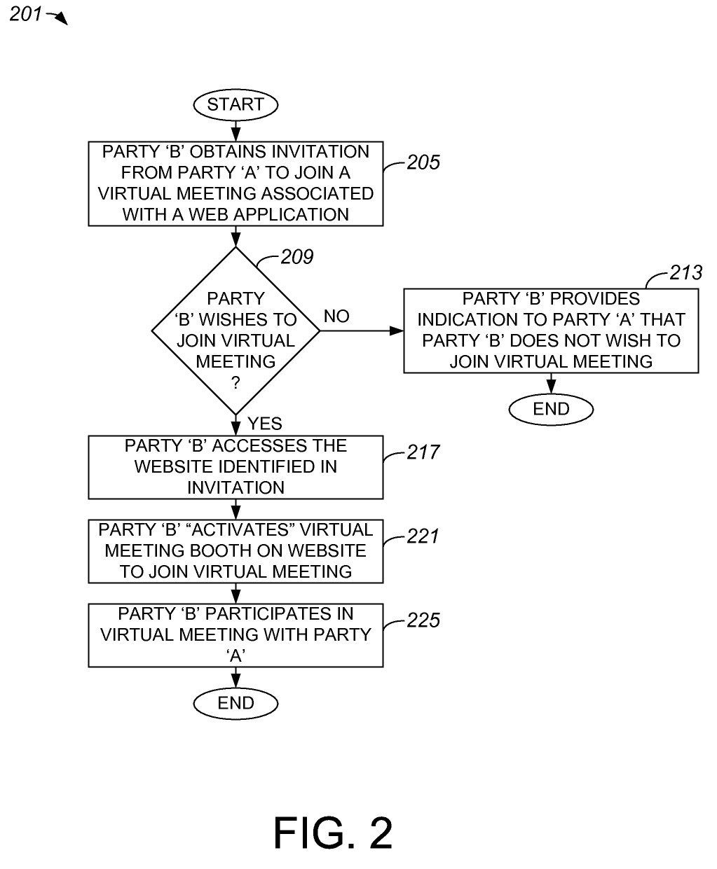

When party ‘B’ receives or otherwise obtains an invitation to join a virtual conference, party ‘B’ may attempt to join the virtual meeting by activating a virtual meeting booth presented on a web application, e.g., the web application which contains a web page that it is desired for party ‘B’ to view. FIG. 2 is a process flow diagram which illustrates one method of joining a virtual meeting using a virtual meeting booth in accordance with an embodiment of the present invention. A process 201 of joining a virtual meeting begins at step 205 in which party ‘B’ obtains an invitation from party ‘A’, or provided substantially at the behest of party ‘A’, that invites party ‘B’ to join a virtual meeting created through a virtual phone booth. Such a virtual meeting is generally associated with a web application that presents the virtual phone booth. The invitation may identify a website associated with the web application which allows the virtual phone booth to be accessed. When party ‘B’ is online with respect to the web application, the invitation may be obtained by party ‘B’ through the web application, e.g., a window may pop up in a web browser that also displays content associated with the web application. If party ‘B’ is not online with respect to the web application, the invitation may be obtained through a phone call, an e-mail, and/or an instant message.

It is determined in step 209 whether party ‘B’ wishes to join the virtual meeting. If it is determined that party ‘B’ does not wish to join the virtual meeting, then party ‘B’ provides an indication to party ‘A’ in step 213 that party ‘B’ does not wish to join the virtual meeting. Such an indication may essentially be provided when party ‘B’ does not join the virtual meeting, e.g., when party ‘B’ essentially ignores the invitation. However, party ‘B’ may instead directly notify party ‘A’ that party ‘B’ does not wish to join the virtual meeting. In one embodiment, when a time to respond to the invitation expires before party ‘B’ joins the virtual meeting, party ‘B’ is considered as providing an indication that he or she does not wish to join the virtual meeting. After party ‘A’ is provided with an indication that party ‘B’ does not wish to join the virtual meeting, the process of joining a virtual meeting is completed.

Returning to step 209, if the determination is that party ‘B’ wishes to join the virtual meeting, then party ‘B’ accesses the website identified in the invitation in step 217. Party ‘B’ may access the website using any suitable method, e.g., party ‘B’ may click on a link contained in the invitation. It should be understood, however, that party ‘B’ may already have accessed the website if he or she is already be on the website when the invitation is obtained. By way of example, if party ‘A’ issued the invitation generally to parties on the same website that party ‘A’ used to activate the virtual meeting booth, then party ‘B’ has already accessed the website.

Once party ‘B’ accesses the website identified in the invitation, party ‘B’ activates the virtual meeting booth on the website to join the virtual meeting in step 221. Party ‘B’ may activate the virtual meeting booth by clicking on an icon that represents the virtual meeting booth, or by making an appropriate selection from a menu. After party ‘B’ activates the virtual meeting booth, party ‘B’ then participates in the virtual meeting in step 225 with party ‘A’. The process of joining a virtual meeting is completed upon party ‘B’ and party ‘A’ participating in the virtual meeting. In the described embodiment, the participation of party ‘B’ in the virtual meeting effectively provides party ‘A’ with an indication that party ‘B’ accepts the invitation. It should be appreciated, however, that party ‘B’ may instead provide party ‘A’ with a separate notification that party ‘B’ intends to participate in the virtual meeting.

In the course of setting up a virtual meeting or a web conference using a virtual meeting booth, a meeting initiator and a meeting invitee may interact with a website that allows access to the virtual meeting booth. The meeting initiator and the meeting invitee, in one embodiment, may additionally communicate with each other outside of the website and, hence, a virtual meeting.

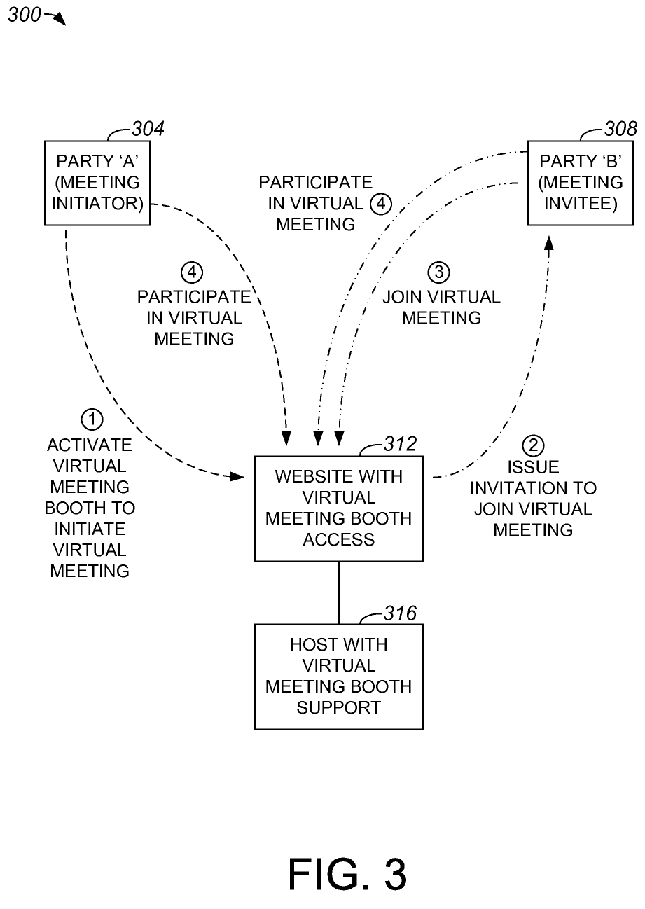

FIG. 3 is a diagrammatic representation of interactions associated with organizing a virtual meeting using a virtual meeting booth in accordance with an embodiment of the present invention in which parties to the virtual meeting communicate through substantially only a website that supports the virtual meeting booth. Within a network 300, party ‘A’ 304, or a meeting initiator, may access a website 312 which includes a virtual meeting booth. Party ‘A’ 304 may generally be an individual who has a computing system that enables him or her to access website 312.

Party ‘A’ 304 may activate a virtual meeting booth presented within website 312. By way of example, if party ‘A’ 304 is viewing a webpage associated with website 312, party ‘A’ 304 may activate the virtual meeting booth to invite party ‘B’ 308, or a meeting invitee, to view the webpage as displayed on a computer screen of party ‘A’ 304. Typically, party ‘B’ 308 is also an individual who has a computing system.

When party ‘A’ 304 activates the virtual meeting booth, website 312 may collaborate with a host 316 that supports a virtual meeting booth, i.e., a host which provides the functionality for website 312 to allow party ‘a’ 304 to create a virtual meeting. In one embodiment, website 312 does not include functionality to actually create a virtual meeting, and instead effectively uses host 316 to create the virtual meeting.

Once party ‘A’ 304 activates the virtual meeting booth associated with website 312, website 312 may issues an invitation to party ‘B’ 308. The invitation may identify party ‘B’ 308. Alternatively, as for example when party ‘A’ 304 specifies that he or she wishes to invite at least one party that is on website 312, the invitation may effectively be generally broadcast to substantially any party who is on website 312. In other words, the invitation may be targeted to party ‘B’ 308 specifically, or may be generally broadcast such that party ‘B’ may obtain the invitation.

Party ‘B’ 308 may join a virtual meeting through access to website 312 and, hence, a virtual meeting booth presented on website 312, when party ‘B’ 308 obtains the invitation to join the virtual meeting. Once party ‘B’ 308 joins the virtual meeting, i.e., a virtual meeting that is effectively supported on host 316 but accessed through a virtual meeting booth on website 312, both party ‘A’ 304 and party ‘B’ 308 may participate in the virtual meeting.

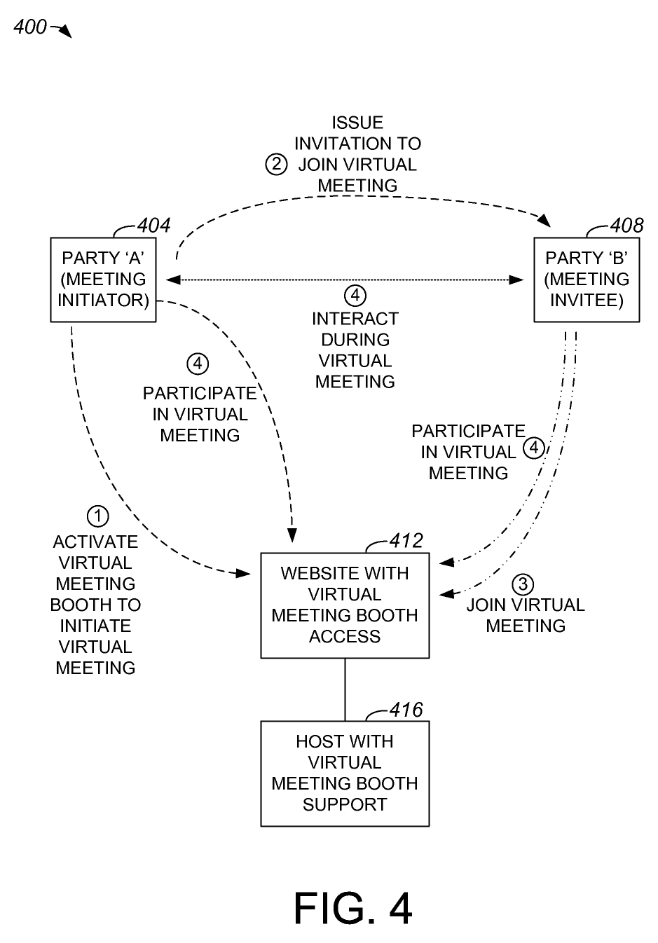

As previously mentioned, a meeting initiator and a meeting invitee may communicate through a virtual meeting while also communicating using other methods. By way of example, a meeting initiator may communicate with a meeting invitee through an instant messaging application while a virtual meeting is ongoing. FIG. 4 is a diagrammatic representation of interactions associated with organizing a virtual meeting using a virtual meeting booth in accordance with an embodiment of the present invention in which parties to the virtual meeting communicate through substantially directly and through a website that supports the virtual meeting booth. In a network 400, party ‘A’ 404 may access a website 412 which includes a virtual meeting booth. Party ‘A’ 404 may activate the virtual meeting booth associated with website 412 to create a virtual meeting.

Website 412 accesses a host 416 to create a virtual meeting when party ‘A’ 404 activates the virtual meeting booth associated with website 412. Website 412 effectively communicates with host 416, which creates a virtual meeting that may be accessed through the virtual meeting booth associated with website 412.

In the described embodiment, party ‘A’ 404 may substantially directly issue an invitation to join the virtual meeting initiated by party ‘A’ 404. The invitation may be issued to party ‘B’ 408 using any suitable method, e.g., by sending an e-mail or instant message. Typically, the invitation may identify website 412 and indicate to party ‘B’ 408 that the virtual meeting may be joined by accessing the virtual meeting booth associated with website 412. By way of example, the invitation may include a link or a web address for a web page that includes a virtual meeting booth that party ‘A’ 404 wants party ‘B’ 408 to access.

While party ‘B’ 408 may accept the invitation by responding substantially directly to party ‘A’ 404, e.g., by sending an e-mail or instant message, party ‘B’ 408 may not necessarily respond substantially directly to party ‘A’ 404. Instead, party ‘B’ 408 may effectively respond to the invitation by joining the virtual meeting identified in the invitation.

Once party ‘B’ 408 joins the virtual meeting through activating the meeting booth associated with website 412, both party ‘A’ 404 and party ‘B’ 408 participate in the virtual meeting. Participating in the virtual meeting may include, but is not limited to including, party ‘A’ 404 and party ‘B’ 408 sharing what is displayed on their computer screens and passing control of what is displayed. While participating in the virtual meeting, party ‘A’ 404 and party ‘B’ 408 may also interact substantially outside of the virtual meeting. By way of example, party ‘A’ 404 and party ‘B’ 408 may interact by sending e-mails, sending instant messages, and/or participating in a phone call substantially while the virtual meeting is ongoing.

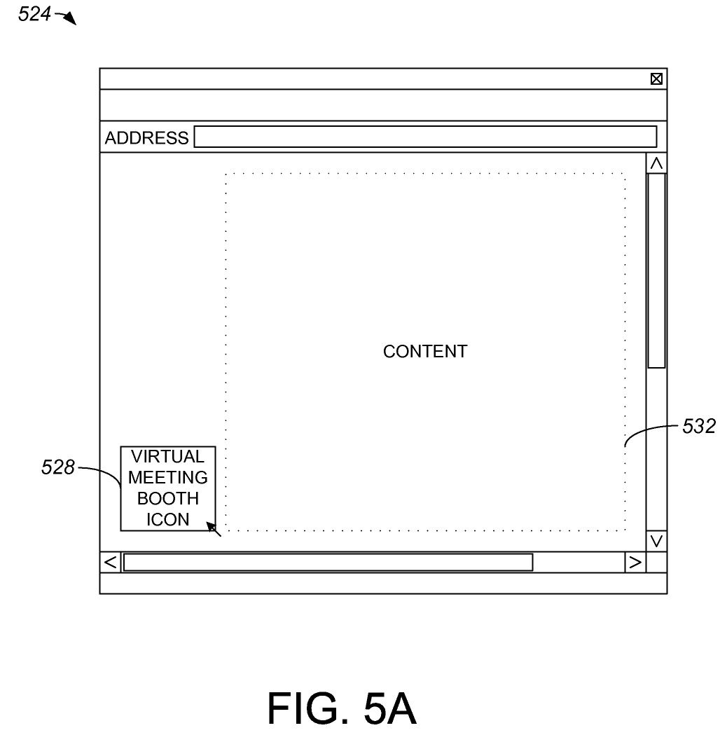

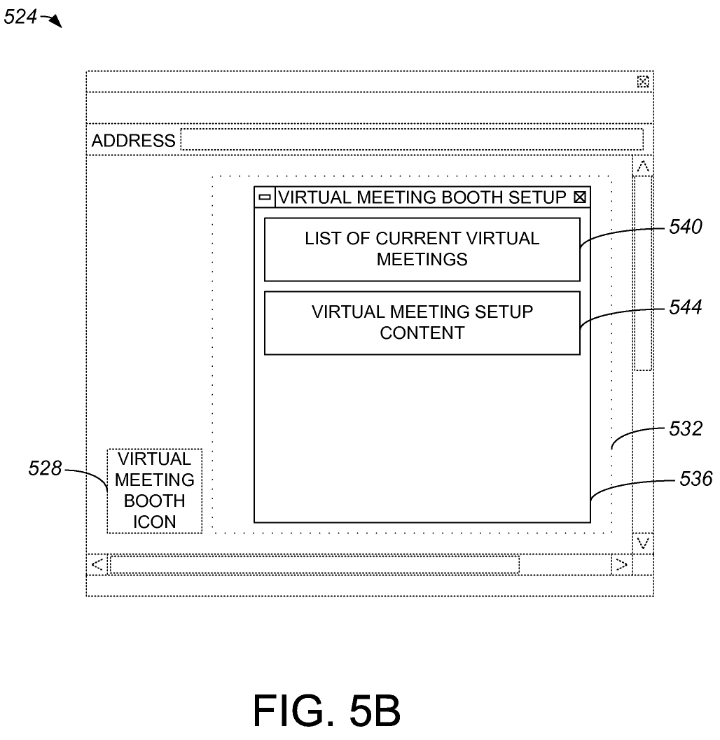

As previously mentioned, a virtual meeting booth may be represented as a logo or an icon on a web page. When a user activates the virtual meeting booth, e.g., by clicking on the icon, the user may initiate a virtual meeting which allows the content of the web page to be shared. FIG. 5A is a diagrammatic representation of a web page on which a virtual meeting booth icon is displayed in accordance with an embodiment of the present invention. A web page 524, which may be displayed on a display screen of a user, is arranged to display content 532. Web page 524 includes a representation of a virtual meeting booth 528 that may be activated to create a virtual meeting, e.g., a virtual meeting used to enable content 532 to be shared.

In one embodiment, activating a virtual meeting booth may include clicking on representation 528 to open a window that enables a user to input information needed to create a virtual meeting, or to join an ongoing virtual meeting. It should be appreciated that although a separate window is described as being opened, an interface which allows a user to create or to join a virtual meeting may instead be provided on web page 524 when representation 528 is clicked on.

FIG. 5B is a diagrammatic representation of a window which opens relative to a web page, e.g., web page 524 of FIG. 5A, after a user activates a virtual meeting booth representation in accordance with an embodiment of the present invention. As shown, a window 536 that allows a virtual meeting to be set up or joined is opened upon activation of representation 528. While window 536 is shown as partially overlapping web page 524, window 536 is not limited to partially overlapping web page 524.

Window 536 may provide a list 540 of current virtual meetings which may be joined, as well as an interface 544 which allows a new virtual meeting to be set up. If window 536 is accessed by a party who has received an invitation to join a particular virtual meeting, the party may identify that particular virtual meeting in list 540, and join that meeting. In some instances, an invitation may include a confirmation code that is used to verify a party as being authorized to join a particular virtual meeting identified list 540.

A meeting initiator who accesses window 536 may set up a virtual meeting using interface 544. Interface 544 may enable a meeting initiator to invite particular parties to join a virtual meeting, e.g., by providing identifying information for the particular parties, and/or may enable a meeting initiator to invite substantially random parties to join a virtual meeting, e.g., all parties who are on a website that includes web page 524.

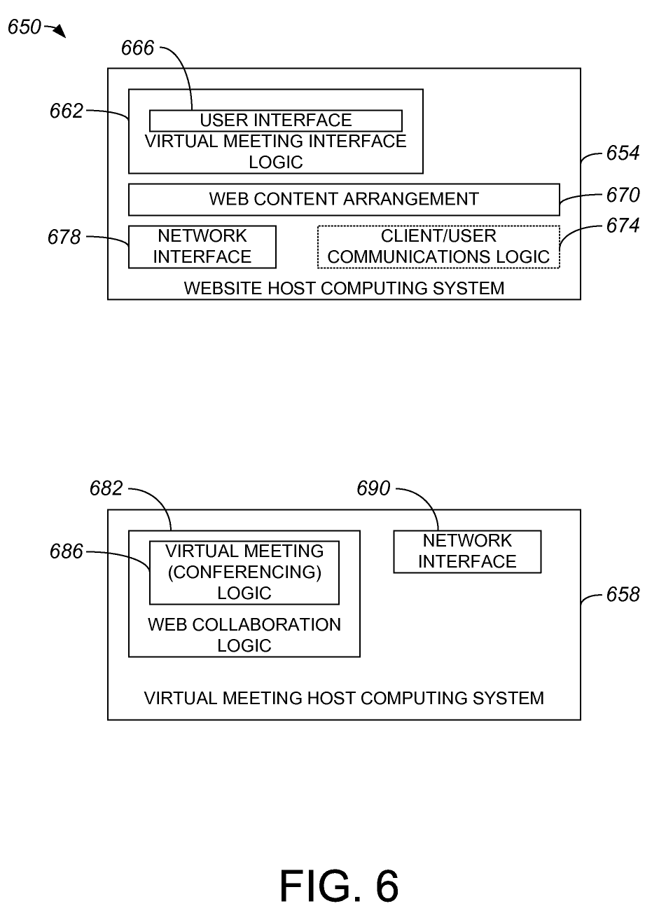

Referring next to FIG. 6, a system in which a website may have an associated virtual meeting booth will be described in accordance with an embodiment of the present invention. A system 650 includes a computing system 654 which hosts a website that provides virtual meeting interface logic 662, and a computing system 658 that includes web collaboration logic 682, e.g., a web conferencing application. Computing system 654 includes a network interface 678 which enables computing system 654 to communicate with computing system 658 and with clients (not shown), e.g., potential participants in a virtual meeting. Computing system 658 includes a network interface 690 which enables computing system 658 to communicate with computing system 654.

Virtual meeting interface logic 662 is generally arranged to enable a client (not shown) who is viewing or otherwise accessing content associated with computing system 654 to effectively set up and participate in a virtual meeting using computing system 658. Virtual meeting interface logic 662 may includes logic which allows one client (not shown) to invite another client (not shown) to join a virtual meeting by accessing a virtual meeting booth associated with computing system 654. A user interface 666 provided by virtual meeting interface logic 662 provides a client (not shown) with the ability to essentially use web collaboration logic 682 without logging onto computing system 658. Virtual meeting interface logic 662 also cooperates with web collaboration logic 682 to allow clients (not shown) to set up virtual meetings and to participate in virtual meetings substantially without entailing that the clients be registered with, e.g., have accounts associated with, a web conferencing application.

In one embodiment, user interface 666 provides a virtual meeting booth on a webpage that is displayed in a web browser associated with a client (not shown). The virtual meeting booth may be provided on a webpage as an icon that may be clicked by a client (not shown) to activate the virtual meeting booth and, hence, to access web collaboration logic 682.

A web content arrangement 670 on computing system 654 is configured to enable content to be displayed on at least one web page that may be viewed by a client (not shown). Computing system 654 optionally includes client communications logic 674 that enables clients (not shown) to communicate with each other substantially outside of a virtual meeting. Client communications logic 674 may include, but is not limited to including, logic which allows clients (not shown) to communicate through e-mail and instant messaging.

Web collaboration logic 682, which is included on computing system 658, provides functionality which enables network connections, e.g., Internet connections, to be used to enable clients (not shown) participating in a virtual meeting or web conference to substantially share content displayed on their computer screens with others. Web collaboration logic 682 may include logic 686 which cooperates with virtual meeting interface logic 662 to enable virtual meetings to be created via computing system 654, i.e.,through user interface 666, and hosted by computing system 658. Logic 686 may also allow invitees to virtual meetings to join the virtual meetings through user interface 666.

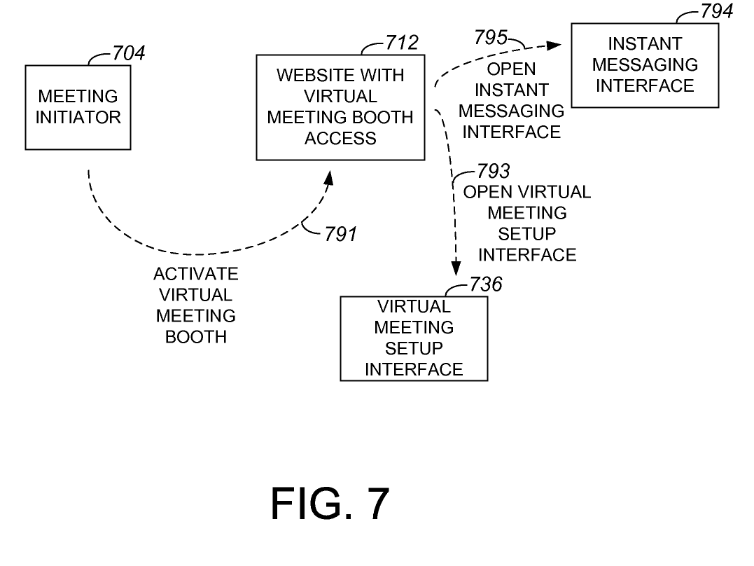

In one embodiment, when a party initiates a virtual meeting by activating a virtual meeting booth on a website, he or she may be provided with both a virtual meeting setup interface and an instant messaging interface. That is, upon activating a virtual meeting booth, in addition to a virtual meeting being substantially initiated, an instant messaging application may be substantially automatically activated to enable a meeting initiator to send an instant message to a meeting invitee. With reference to FIG. 7, the activation of an instant messaging application in response to the activation of a virtual meeting booth will be described in accordance with an embodiment of the present invention. A meeting initiator 704 may activate a virtual meeting booth in step 791 that is associated with a website 712. When the virtual meeting booth is activated, website 712 may cause a virtual meeting setup interface 736 to be opened in step 793. In general, website 712 may cooperate with a virtual meeting host application (not shown), e.g., a web conferencing application, to enable a virtual meeting to be created using interface 736.

An instant messaging interface 794 is opened in step 795 by website 712 when the virtual meeting booth is activated. Instant messaging interface 794 may be an instant messaging window which allows meeting initiator 704 to send an instant message to a recipient, e.g., a party that meeting initiator 704 wishes to invite to participate in a virtual meeting.

Although only a few embodiments of the present invention have been described, it should be understood that the present invention may be embodied in many other specific forms without departing from the spirit or the scope of the present invention. By way of example, sharing a web page or document viewed through a web browser has generally been described. However, the use of a virtual meeting booth is not limited to being associated with a web application. A virtual meeting booth may be incorporated with respect to substantially any application, and may be used to enable a user to share his or her desktop.

The present invention may be implemented as hardware and/or software logic embodied in a tangible medium that, when executed, is operable to perform the various methods and processes described above. For example, the logic that enables a computing system to provide a virtual meeting booth may be implemented as hardware logic, software logic, or a combination of both hardware and software logic.

A website which supports a virtual meeting booth, i.e., a website which hosts a web page from which a virtual meeting booth may be accessed, may be arranged to charge a fee for creating and/or attending a virtual meeting created through the virtual meeting booth. For instance, when a party activates a virtual meeting booth, he or she may be presented with an interface which allows the party to pay to set up a virtual meeting. Such an interface may allow a party to enter a credit card number and, upon processing a payment made using the credit card number, allow the party to initiate a virtual meeting.

When a virtual meeting booth displayed on a web page is activated to create a virtual meeting, the contents of that web page, as displayed on a display screen of a meeting initiator, may be shared in that virtual meeting. In one embodiment, once a virtual meeting is created using a virtual meeting booth on a web page, substantially anything displayed on a display screen of any of the participants in the virtual meeting may be shared. That is, a virtual meeting initiated using a virtual meeting booth on a web page is not limited to being used to share content associated with that web page.

Any number of parties may participate in a virtual meeting that is set up through a virtual meeting booth. Each party that participates in a virtual meeting may access the virtual meeting through a virtual meeting booth.

A virtual meeting booth has generally been described as being presented as a graphic or an icon on a web page of a browser. It should be appreciated, however, that a virtual meeting booth is not limited to being presented as an icon that a user may effectively activate. For example, a virtual meeting booth may instead be presented as a selection in a drop down menu or a pop up menu associated with a web page.

An invitation to join a virtual meeting created using a virtual phone booth may be sent or otherwise provided by a meeting initiator or a website or application associated with the virtual phone booth, e.g., a website with a web page through which the virtual phone booth is accessible, as described above. In one embodiment, an invitation to join a virtual meeting may issued by the application which is sets up the virtual meeting, i.e., the application which is accessed through a virtual phone booth.

The steps associated with the methods of the present invention may vary widely. Steps may be added, removed, altered, combined, and reordered without departing from the spirit of the scope of the present invention. Therefore, the present examples are to be considered as illustrative and not restrictive, and the invention is not to be limited to the details given herein, but may be modified within the scope of the appended claims.

What is claimed is:

1. A method comprising:
obtaining at a first location a request to initiate a web conference, the request being obtained from a first party;
communicating with a second location, wherein the second location is configured to create the web conference based on the request;
determining when the web conference is created by the second location; and
issuing an invitation to at least a second party when it is determined that the web conference is created by the second location, the invitation being arranged to invite the second party to participate in the web conference with the first party.

2. The method of claim 1 wherein the request identifies the second party as being a desired participant in the web conference.

3. The method of claim 1 wherein the first location includes a virtual meeting booth interface, and the request is obtained from the first party through the virtual meeting booth interface, the virtual meeting booth interface being arranged to communicate with the second location.

4. The method of claim 3 wherein the first location is a website and the second location is a web conferencing application.

5. The method of claim 4 wherein the second party is logged onto the website when the invitation is issued.

6. The method of claim 4 wherein the virtual meeting booth interface allows the web conference to be created in response to the request obtained from the first party without the first party accessing the web conferencing application.

7. The method of claim 1 further including:
joining the first party to the web conference.

8. The method of claim 7 further including:
obtaining at the first location an indication, the indication being arranged to indicate that the second party intends to join the web conference; and
joining the second party to the web conference.

9. The method of claim 8 further including:
providing an instant messaging interface that enables the first party to communicate with the second party during the web conference.

10. The method of claim 8 wherein the request is received through a virtual meeting booth, and wherein obtaining the indication includes receiving the indication through the virtual meeting booth.

11. Logic encoded in one or more tangible media for execution and when executed operable to:
obtain at a first location a request to initiate a web conference, the request being obtained from a first party;
communicate with a second location, wherein the second location is configured to create the web conference based on the request;
determine when the web conference is created by the second location; and
issue an invitation to at least a second party when it is determined that the web conference is created by the second location, the invitation being arranged to invite the second party to participate in the web conference with the first party.

12. The logic of claim 11 wherein the request identifies the second party as being a desired participant in the web conference.

13. The logic of claim 11 wherein the first location includes a virtual meeting booth interface, and the request is obtained from the first party through the virtual meeting booth interface, the virtual meeting booth interface being arranged to communicate with the second location.

14. The logic of claim 13 wherein the first location is a website and the second location is a web conferencing application.

15. The logic of claim 14 wherein the second party is logged onto the website when the invitation is issued.

16. The logic of claim 14 wherein the virtual meeting booth interface allows the web conference to be created in response to the request obtained from the first party without the first party accessing the web conferencing application.

17. The logic of claim 11 further operable to:
join the first party to the web conference.

18. The logic of claim 17 further operable to:
obtain at the first location an indication, the indication being arranged to indicate that the second party intends to join the web conference; and
join the second party to the web conference.

19. The logic of claim 18 further operable to:
provide an instant messaging interface that enables the first party to communicate with the second party during the web conference.

20. The logic of claim 18 wherein the request is received through a virtual meeting booth, and wherein the logic operable to obtain the indication is further operable to receive the indication through the virtual meeting booth.

21. An apparatus comprising:
means for obtaining at a first location a request to initiate a web conference, the request being obtained from a first party;
means for communicating with a second location, wherein the second location is configured to create the web conference based on the request;
means for determining when the web conference is created by the second location; and
means for issuing an invitation to at least a second party when it is determined that the web conference is created by the second location, the invitation being arranged to invite the second party to participate in the web conference with the first party.

22. An apparatus comprising:
a first interface, the first interface being arranged to obtain a request to create a virtual meeting;
an arrangement, the arrangement being arranged to display viewable content, the arrangement further being arranged to display a representation of a first interface;
a second interface, the second interface being arranged to communicate with an external application to create the virtual meeting when the request is obtained, the second interface further being arranged to obtain information from the external application when the virtual meeting is created; and
logic configured to issue at least one invitation to join the virtual meeting when the virtual meeting is created.

23. The apparatus of claim 22 wherein the first interface is arranged to obtain the request to create a virtual meeting from a first party, and wherein the logic is configured to issue the at least one invitation to a second party.

24. The apparatus of claim 23 wherein the representation is displayed on a web page that displays the viewable content.

25. The apparatus of claim 23 wherein the second interface is further arranged to join the first party and the second party in the virtual meeting.

26. The apparatus of claim 25 wherein the second interface is further arranged to enable the first party to communicate with the second party separately from the virtual meeting.

27. The apparatus of claim 26 wherein the second interface is further arranged to enable the first party to communicate with the second party through an instant messaging interface.
